(19) United States
(12) Patent Application Publication
(10) Pub. No.: US 2025/0109907 A1
(43) Pub. Date: Apr. 3, 2025

(54) RECEPTACLE DRYING SYSTEM AND METHOD

(71) Applicant: Pulpex Limited, Sawston (GB)

(72) Inventor: Alistair Hugh William KIRKWOOD, Sawston (GB)

(21) Appl. No.: 18/977,515

(22) Filed: Dec. 11, 2024

Related U.S. Application Data
(63) Continuation of application No. PCT/GB2023/051601, filed on Jun. 20, 2023.

(30) Foreign Application Priority Data
Jun. 21, 2022 (GB) 2209122.7

(51) Int. Cl. F26B 21/00; D21J 1/06; F26B 15/18; F26B 21/08; F26B 21/10; F26B 21/12

(52) U.S. Cl. CPC F26B 21/006; D21J 1/06; F26B 21/10; F26B 21/12; F26B 15/18; F26B 21/08

(57) ABSTRACT

Disclosed is a method of drying an interior of a receptacle formed from a fibre suspension, the method comprising directing an airflow into an opening of the receptacle at a position offset from a centre of the opening. Also disclosed is a nozzle module for use in drying an interior of a receptacle formed from a fibre suspension, a fibre-based receptacle drying system for use in drying an interior of a receptacle formed from a fibre suspension, and a receptacle obtainable or obtained from a fabrication method comprising the disclosed method.

### CROSS-REFERENCE TO RELATED APPLICATIONS

This application is a continuation under 35 U.S.C. § 120 of International Application No. PCT/GB2023/051601, filed Jun. 20, 2023, which claims priority to United Kingdom Application No. GB 2209122.7, filed Jun. 21, 2022 under 35 U.S.C. § 119(a). Each of the above-referenced patent applications is incorporated by reference in its entirety.

### TECHNICAL FIELD

The present invention relates to methods and systems of drying an interior of a receptacle formed from a fibre suspension, such as a fibre suspension comprising paper pulp. The receptacles may form consumer packaging, such as bottles, useful for holding liquids, powders, other flowable materials or solid objects.

### BACKGROUND

It is desirable to reduce plastics use in consumable items, particularly packaging. Trays and other simple shapes are commonly made from paper pulp, but more complex objects, such as bottles, are more difficult to engineer.

A receptacle formed from a fibre suspension may undergo one or more drying processes during its manufacture. For example, the receptacle may be dried to remove remaining liquid from the fibre suspension after the receptacle has been formed and/or one or more coatings on the receptacle may be dried. Such drying processes often include subjecting the receptacle to heat to decrease drying time, but excessive heat may cause damage to the receptacle and/or to any coating on the receptacle.

### SUMMARY

According to a first aspect of the present invention, there is provided a method of drying an interior of a receptacle formed from a fibre suspension, the method comprising directing an airflow into an opening of the receptacle at a position offset from a centre of the opening. Directing an airflow into an opening of a receptacle is known to assist in drying an interior of the receptacle. By offsetting the airflow from the centre of the opening, the airflow is caused to flow along the side of the interior of the receptacle towards a base of the receptacle, along the base of the receptacle, and then along another side of the interior of the receptacle towards and back out through the opening. This helps to remove moisture from the interior of the receptacle.

In some examples, the method is a method of drying an interior of a bottle formed from a fibre suspension. In some examples, the method is a method of drying an interior coating of the receptacle.

In some examples, the directing comprises directing the airflow into the opening of the receptacle at the position offset from the centre of the opening such that the airflow travels along a side of the interior of the receptacle. It has been found that directing airflow along an interior side of a receptacle in the form of a bottle causes the airflow to pass over and follow the shape of a shoulder of the bottle, for example under the influence of the Coanda effect, which does not occur when airflow is directed into the opening without being directed along an interior side of the bottle.

In some examples, the method comprises emitting the airflow from a nozzle, and causing relative movement between the receptacle and the nozzle. Such relative movement causes the opening to move relative to the source of the airflow, which may in turn vary a route that the airflow takes within the interior of the receptacle over time. This may cause the airflow to pass over a greater surface area of the interior of the receptacle than were the relative movement not to occur, which may reduce a drying time of the interior of the receptacle.

In some examples, the relative movement is in a first direction and the position is a position offset laterally, relative to the first direction, from the centre of the opening. The magnitude of the lateral offset of the position may be such that the airflow travels along a lateral side, relative to the first direction, of the interior of the receptacle, the advantage of which is described above.

In some examples, the airflow has a speed from 0.5 m/s to 5 m/s. Airflow in this speed range has been found to provide beneficial drying effects compared with greater or lesser speeds. Greater speeds may risk damaging the interior of the receptacle and/or an interior coating of the receptacle. At lesser speeds, the airflow may not travel as far as to a base of the receptacle and/or may not cause sufficient evacuation of moisture from the interior of the receptacle. In some examples, the airflow is emitted from the nozzle at a speed from 0.5 m/s to 5 m/s.

In some examples, the airflow has a temperature from 40 to 100 degrees Centigrade. Airflow in this temperature range has been found to provide beneficial drying effects compared with hotter or cooler temperatures. Hotter temperatures may risk damaging the interior of the receptacle and/or an interior coating of the receptacle. Cooler temperatures may not sufficiently cause evaporation of moisture within the interior of the receptacle. In some examples, the temperature is from 55 to 85 degrees Centigrade.

In some examples, the method comprises directing plural airflows into the opening of the receptacle, wherein at least two of the plural airflows are directed into the opening at different respective positions relative to, and offset from, the centre of the opening, wherein the magnitudes of the respective offsets are such that the at least two airflows travel from the opening along different sides of the interior of the receptacle. This causes the at least two airflows to flow along different routes within the interior of the receptacle. This can result in faster, more uniform drying of the interior of the receptacle and/or an interior coating of the receptacle. This can also reduce a required temperature and/or flow rate of the plural airflows. The positions may be at other than opposite sides of the opening. In such circumstances, the routes of the airflows do not overly each other, so a greater percentage area of the interior surface(s) of the receptacle is passed over by the airflows, compared with directing only one airflow into the opening.

In some examples, the plural airflows are directed into the opening of the receptacle successively. By successively directing the plural airflows into the opening, each airflow can freely enter the receptacle without interference from another airflow at the opening. This can help to reliably remove moisture from the receptacle, which in turn can reduce a drying time of the interior of the receptacle.

In some examples, the method comprises directing the plural airflows into the opening of the receptacle non-concurrently to one another. Interference between airflows in an interior of a receptacle can cause interference currents and/or eddy currents to form, which may prevent moist air from passing out of the receptacle. In turn, moist air trapped in the interior of the receptacle may slow a drying process of the interior of the receptacle.

In some examples, the method comprises emitting each of the plural airflows from a respective one of a plurality of nozzles, and causing relative movement of the receptacle and the plurality of nozzles, wherein the nozzles are offset from one another in a direction of the relative movement. This may help to ensure that the plural airflows are directed into the opening successively since, due to the relative movement, the opening of the receptacle comes into alignment with each nozzle of the plurality of nozzles at a different time to coming into alignment with another nozzle of the plurality of nozzles.

In an example, only one of the nozzles is aligned with the opening at any one time. This may help to ensure that the plural airflows are directed into the opening non-concurrently with one another, which may reduce interference between the plural airflows within the interior of the receptacle.

In some examples, at least two of the plurality of nozzles are offset from one another in a direction normal to the relative movement. Accordingly, the airflows emitted from the at least two of the plurality of nozzles may enter the opening at different lateral positions relative to the direction of relative movement.

In an example, one or all of the airflows emitted from the at least two of the plurality of nozzles travel along a lateral, relative to the direction of relative movement, side of the interior of the receptacle. This may help to increase the percentage area of the interior surface(s) of the receptacle that is passed over by the airflows.

In some examples, each nozzle is configured to direct the respective airflow substantially vertically downwards. This has been found to provide sufficient coverage of the interior of a receptacle when the receptacle is oriented with its opening facing substantially vertically upwards. This also helps to prevent lateral forces being applied to the receptacle by the airflows, which may, for example, topple the receptacle during the drying process.

In some examples, the method comprises emitting respective airflows from the plurality of nozzles at substantially the same speed as each other. This may help to increase the reliability and repeatability of the method since each of the airflows enters the receptacle at substantially the same speed and therefore provides substantially similar drying effects on the interior of the receptacle.

In some examples, the method comprises emitting an airflow from each nozzle of a first group of the plurality of nozzles at a first speed and emitting an airflow from each nozzle of a second, different group of the plurality of the nozzles at a second speed, different to the first speed. This may help to increase the controllability of the method.

In some examples, the method comprises emitting respective airflows from the plurality of nozzles at substantially the same temperature as each other. This may help to increase the reliability and repeatability of the method since each of the airflows enters the receptacle at substantially the same temperature and therefore provides substantially similar drying effects on the interior of the receptacle.

In some examples, the method comprises emitting an airflow from each nozzle of a first group of the plurality of nozzles at a first temperature and emitting an airflow from each nozzle of a second, different group of the plurality of the nozzles at a second temperature, different to the first temperature. This may help to increase the controllability of the method.

In some examples, the method comprises directing additional airflows towards an outer surface of the receptacle. This may help to concurrently dry an exterior of the receptacle.

According to a second aspect of the present invention, there is provided a nozzle module for use in drying an interior of a receptacle formed from a fibre suspension, the nozzle module comprising plural groups of nozzles, wherein the groups of nozzles are aligned successively along a path, and wherein the nozzles in each group of nozzles are laterally offset from one another, relative to the path, such that, in use, the nozzles in a group of nozzles are configured to emit respective airflows into different respective regions of an opening of the receptacle. By entering the receptacle opening at the different regions, each airflow emitted from a group of nozzles takes a different route into and out of the receptacle. Accordingly, a greater proportion of the interior is dried by the airflows, than were plural airflows all to enter the receptacle at the same location within the opening. This can result in faster, more uniform drying of the interior. This can also reduce the required temperature and/or flow rate of the airflows.

By positioning the groups of nozzles successively, the airflows emitted from one of the groups of nozzles can freely exit the receptacle via the opening without interference from airflows emitted from a successive one of the groups of nozzles. This can help to reliably remove moisture from the receptacle, which in turn can reduce a drying time of the interior.

Providing plural groups of nozzles may allow a plurality of receptacles to be dried concurrently, for example with a receptacle aligned with at least one nozzle of one the groups of nozzles and another receptacle aligned with at least one nozzle of another of the groups of nozzles.

Providing nozzles, rather than simple holes, has been found to provide better directionality of the respective airflows.

In some examples, the receptacle is a bottle.

In some examples, the path is in the region of 0.5 m to 1.5 m in length.

In some examples, the path is linear. This enables linear relative movement of the receptacle and the groups of nozzles while ensuring that the nozzles would all align with the opening when desired. In turn, this may simplify construction and operation of a drying system in which the nozzle module may be employed.

In some examples, the nozzle module comprises a tray to support the nozzles, the tray comprising plural groups of holes corresponding to the plural groups of nozzles. In some examples, each nozzle comprises a flange configured to engage with a rear surface of the tray. This has been found to be a simple and efficient way to accurately retain the nozzles in their respective desired positions.

In some examples, the nozzle module comprises from 10 to 20 groups of nozzles.

In some examples, the nozzles in each of the groups of nozzles are longitudinally offset from one another along the path. In use, the receptacle may be movable relative to the nozzle module such that the opening of the receptacle moves along the path. By providing the nozzles in a group of nozzles in positions longitudinally offset from one another, each individual airflow emitted from the nozzle module may enter the opening of the receptacle non-concurrently with any other airflow from one of the nozzles. Directing the airflows into the receptacle non-concurrently can help to prevent the airflows interfering with one another as the airflows flow through the interior of the receptacle. In turn, this can help to ensure that the airflows escape the receptacle promptly.

In some examples, each nozzle in one of the groups of nozzles is aligned with a respective nozzle in each of the other groups of nozzles in a direction parallel to the path. This may provide more reliability and repeatability in drying the interior of the receptacle because corresponding nozzles in different groups of nozzles direct their respective airflows into the same respective region of the opening of the receptacle. The airflows are therefore directed into and through the interior of the receptacle in a repeatable manner.

In some examples, a spacing between adjacent nozzles within any one of the groups of nozzles is substantially equal to a spacing between other adjacent nozzles within the any one of the groups of nozzles. This may help to increase the controllability of the nozzle module in use.

In some examples, a spacing between adjacent groups of the groups of nozzles along the path is greater than each spacing between adjacent nozzles within any one of the groups of nozzles. This may further help the airflows emitted from one of the groups of nozzles to freely exit the receptacle via the opening without interference from airflows emitted from another one of the groups of nozzles.

In some examples, the nozzles in each of the groups are arranged identically to the nozzles in each other of the groups. This may help to increase the controllability of the method.

In some examples, the nozzle module comprises a heater configured to cause the respective airflows to have a temperature above an ambient temperature. This may help to decrease a drying time of the receptacle.

In some examples, the heater is configured to cause the respective airflows to be at a temperature from 40 to 100 degrees Centigrade, such as from 55 to 85 degrees Centigrade. Airflow in this temperature range has been found to provide beneficial drying effects compared with hotter or cooler temperatures. Hotter temperatures may risk damaging the interior of the receptacle. Cooler temperatures may not evaporate sufficient moisture within the interior of the receptacle.

In some examples, the heater is configured to cause all of the respective airflows to be heated to substantially the same temperature as each other. This may provide more reliability and repeatability in drying the interior of the receptacle since each of the airflows is therefore emitted at substantially the same temperature and thus provides substantially similar drying effects on the interior of the receptacle.

In some examples, the heater is configured to heat the airflows emitted from a first group of the groups of nozzles to a first temperature and to heat the airflows emitted from a second group of the groups of nozzles to a second temperature, different to the first temperature. It may be beneficial to increase a temperature of the airflows as the receptacle becomes drier, for example to reduce a drying time of the interior of the receptacle.

In some examples, the nozzle module is configured to emit the respective airflows from the nozzles at a speed from 0.5 m/s to 5 m/s. Airflow in this speed range has been found to provide beneficial drying effects compared with greater or lesser speeds. Greater speeds may risk damaging the interior of the receptacle. At lesser speeds, the airflow may not travel to a base of the receptacle and/or may not cause sufficient evacuation of moisture from the interior of the receptacle.

In some examples, the nozzle module is configured to emit all of the respective airflows at substantially the same speed. This may provide more reliability and repeatability in drying the interior of the receptacle since each of the airflows is emitted at substantially the same speed and therefore provides substantially similar drying effects on the interior of the receptacle.

In some examples, the nozzle module comprises additional nozzles configured to direct respective airflows towards an outer surface of the receptacle. This may help to concurrently dry an exterior of the receptacle.

In some examples, the nozzle module comprises plural parallel rows of nozzles, each row comprising a respective plurality of groups of nozzles, wherein the nozzles in a first row of the rows are spaced apart from the nozzles in an adjacent second row of the rows by a distance that is greater than a distance between adjacent groups of nozzles in each of the first and second rows. This may allow concurrent drying of a plurality of rows of receptacles by the nozzle module.

In some examples, the nozzles in each of the rows are arranged identically to the nozzles in each of the other rows. This may help to increase the controllability of the method.

In some examples, a distance between a left-most and a right-most nozzle, relative laterally to the path, within a group of nozzles is smaller than a distance between the nozzles in the first row and the nozzles in the second row.

According to a third aspect of the present invention, there is provided a fibre-based receptacle drying system for use in drying an interior of a receptacle formed from a fibre suspension, the drying system comprising a receptacle support to support the receptacle and a group of nozzles arranged to direct respective airflows towards the receptacle support, wherein the receptacle support and the group of nozzles are relatively movable in a direction of movement, and wherein the nozzles in the group of nozzles are offset laterally and longitudinally from one another with respect to the direction of movement, such that, in use, during the relative movement, the respective airflows are successively directed into different respective regions of an opening of the receptacle. By entering the receptacle opening at the different regions, each airflow emitted from a nozzle of the group of nozzles takes a different route into and out of the receptacle. Accordingly, a greater proportion of the interior is dried by the airflows, than were plural airflows all to enter the receptacle at the same location within the opening. This can result in faster, more uniform drying of the interior. This can also reduce the required temperature and/or flow rate of the airflows. In use, the relative movement of the receptable support and the group of nozzles causes the receptacle to pass the group of nozzles such that the respective airflows from the nozzles enter the opening of the receptacle successively.

In some examples, the airflows emitted from the group of nozzles enter the opening of the receptacle non-concurrently. By applying the airflows non-concurrently, each airflow can freely exit the receptacle via the opening without interference from another of the airflows. This can help to reliably remove moisture from the receptacle, which in turn can reduce a drying time of the interior of the receptacle.

Providing nozzles, rather than simple holes, has been found to provide better directionality of the respective airflows.

In some examples, the fibre-based receptacle drying system is a bottle drying system.

In some examples, the fibre-based receptacle drying system is for use in drying an interior coating of the receptacle.

In some examples, each nozzle is configured to direct the respective airflow substantially vertically downwards. This has been found to provide sufficient coverage of the interior of a receptacle when the receptacle is oriented with its opening facing substantially vertically upwards. This also help to prevent lateral forces being applied to the receptacle by the airflows, which may, for example, topple the receptacle during use of the fibre-based receptacle drying system.

In some examples, the fibre-based receptacle drying system is configured to emit the respective airflows from the nozzles at a speed from 0.5 m/s to 5 m/s. Airflow in this speed range has been found to provide beneficial drying effects compared with greater or lesser speeds. Greater speeds may risk damaging the interior of the receptacle. At lesser speeds, the airflow may not travel to a base of the receptacle and/or may not cause sufficient evacuation of moisture from the interior of the receptacle.

In some examples, the fibre-based receptacle drying system is configured to emit all of the respective airflows at substantially the same speed. This may provide more reliability and repeatability in drying the interior of the receptacle since each of the airflows is emitted at substantially the same speed and therefore provides substantially similar drying effects on the interior of the receptacle.

In some examples, the fibre-based receptacle drying system comprises a drying chamber between the group of nozzles and the receptacle support, and an exhaust system to draw out air from the drying chamber. Drawing out moist air from the drying chamber can help to reduce a required heat and/or speed of the respective airflows to dry the receptacle. In some examples, the receptacle support may be air-permeable, for example may comprise a plurality of holes or slots, to allow the exhaust system to draw air through the receptacle support and away from receptacles positioned on the receptacle support.

In some examples, the fibre-based receptacle drying system comprises a recirculation system to direct air from the exhaust system to the group of nozzles. This can increase the efficiency of the drying system: for example, in examples in which the respective airflows are heated above an ambient temperature. The recirculation system can help reduce the energy required to heat the respective airflows when the recirculated air is at a temperature above an ambient temperature.

In some examples, the group of nozzles is located above the receptacle support and the exhaust system is located below the receptacle support. This may provide a more efficient system since the airflow emitted from the nozzles are generally directed towards the exhaust system.

In some examples, the fibre-based receptacle drying system comprises an adjuster to adjust a distance between the nozzles and the receptacle support. This may allow the drying system to be used to dry receptacles of different dimensions. It has been found that it is beneficial for a distance between the nozzles and the opening of the receptacle to be from 5 mm to 30 mm. At greater distances, the respective airflows can diffuse before entering the receptacle. At lesser distances, the airflows can be too strong and can, for example, blow a coating on an interior surface of the receptacle too fiercely such that the coating may become non-uniform and/or a full thickness of the coating is not sufficiently dried.

In some examples, the fibre-based receptacle drying system comprises a heater configured to cause the respective airflows to have a temperature greater than an ambient temperature. This may help to decrease a drying time of the receptacle.

In some examples, the heater is configured to cause the respective airflows to have a temperature from 40 to 100 degrees Centigrade, such as from 55 to 85 degrees Centigrade. Airflow in this temperature range has been found to provide beneficial drying effects compared to hotter or cooler temperatures. Hotter temperatures may risk damaging the interior of the receptacle. Cooler temperatures may not evaporate sufficient moisture within the interior of the receptacle.

In some examples, the heater is configured to cause all of the respective airflows to be heated to substantially the same temperature. This may provide more reliability and repeatability in drying the interior of the receptacle since each of the airflows is therefore emitted at substantially the same temperature and thus provides substantially similar drying effects on the interior of the receptacle.

In some examples, the receptacle is a circular receptacle and has a central opening, and the fibre-based receptacle drying system comprises an alignment mechanism to align the receptacle relative to the group of nozzles.

In some examples, the fibre-based receptacle drying system comprises plural groups of nozzles aligned successively along a path, wherein a spacing between adjacent groups of the groups of nozzles along the path is greater than each spacing between adjacent nozzles within any one of the groups of nozzles. This may further help the airflows emitted from one of the groups of nozzles to freely exit the receptacle via the opening without interference from airflows emitted from another one of the groups of nozzles. This may allow a plurality of receptacles to be concurrently dried by the drying system.

In some examples, the nozzle module comprises from 10 to 20 groups of nozzles.

In some examples, each nozzle in one of the groups of nozzles is aligned with a respective nozzle in each of the other groups of nozzles in a direction parallel to the path. This may provide more reliability and repeatability in drying the interior of the receptacle.

In some examples, a spacing between adjacent nozzles within any one of the groups of nozzles is substantially equal to a spacing between other adjacent nozzles within the any one of the groups of nozzles. This may help to increase the controllability of the nozzle module in use.

In some examples, the nozzles in each of the groups are arranged identically to the nozzles in each other of the groups. This may help to increase the controllability of the method.

In some examples, the heater is configured cause the airflows emitted from a first group of the groups of nozzles to be heated to a first temperature, and the airflows emitted from a second group of the groups of nozzles to be heated to a second temperature, different to the first temperature. This may allow more control over the drying by the drying system.

In some examples, the fibre-based receptacle drying system comprises plural parallel rows of nozzles, each row comprising a respective plurality of groups of nozzles, wherein the nozzles in a first row of the rows are spaced apart from the nozzles in an adjacent second row of the rows by a distance that is greater than a distance between adjacent groups of nozzles in each of the first and second rows. This may allow concurrent drying of a plurality of rows of receptacles by the fibre-based receptacle drying system.

In some examples, the nozzles in each of the rows are arranged identically to the nozzles in each of the other rows. This may help to increase the controllability of the method.

In some examples, a distance between a left-most and a right-most nozzle, relative laterally to the path, within a group of nozzles is smaller than a distance between the nozzles in the first row and the nozzles in the second row.

According to a fourth aspect of the present invention, there is provided a receptacle obtainable or obtained from a fabrication method comprising the method of the first aspect of the present invention. For example, the receptacle may be obtainable or obtained from the method of the first aspect of the present invention.

The fabrication method may comprise at least one additional process. The at least one additional process may comprise moulding the receptacle to produce a moulded receptacle. The at least one additional process may comprise coating the receptacle or the moulded receptacle to produce a coated receptacle. The at least one additional process may comprise applying a closure to the receptacle, the moulded receptacle or the coated receptacle.

In some examples, the receptacle is a bottle.

### BRIEF DESCRIPTION OF DRAWINGS

Embodiments of the invention will now be described, by way of example only, with reference to the accompanying drawings, in which:

FIG. 1 is a schematic view of an example process for making bottles from paper pulp;

FIG. 2 is a schematic view of an example fibre-based receptacle drying system for use in drying an interior of a receptacle formed from a fibre suspension;

FIG. 3 is a schematic plan view of an example nozzle module for use in drying an interior of a receptacle formed from a fibre suspension;

FIGS. 4A-4D are schematic plan views of a receptacle relative to an example group of nozzles for use in drying an interior of a receptacle formed from a fibre suspension;

FIGS. 5A and 5B are schematic views of example airflows through an interior of an example fibre-based receptacle;

FIG. 6 is a flow diagram depicting an example method of drying an interior of a receptacle formed from a fibre suspension; and

FIG. 7 is a flow diagram depicting a further example method of drying an interior of a receptacle formed from a fibre suspension.

### DETAILED DESCRIPTION

The following description presents exemplary embodiments and, together with the drawings, serves to explain principles of embodiments of the invention.

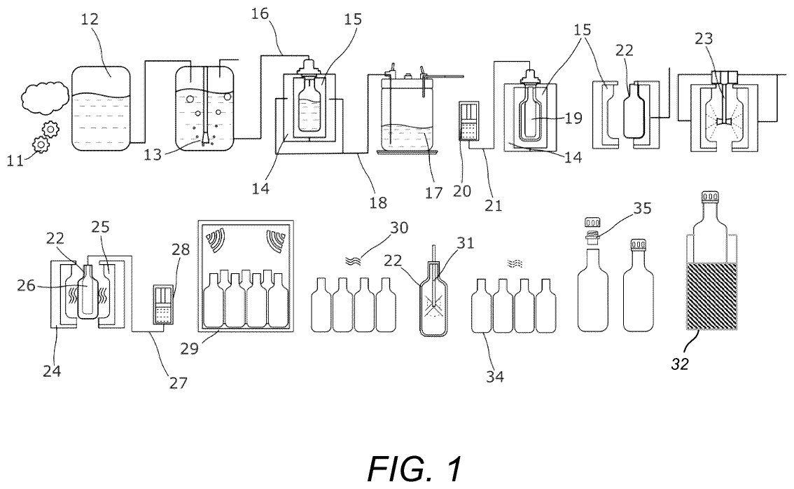

FIG. 1 shows a process for making bottles from paper pulp (i.e., which can form the basis of an example fibre suspension). The process is merely exemplary and is provided to give context to examples of the present invention. Broadly speaking, the exemplary process comprises providing a fibre suspension, introducing the fibre suspension into a mould cavity of a porous first mould and using the porous first mould to expel a liquid (such as water) from the fibre suspension to produce a wet precursor or embryo (which may itself be considered a moulded receptacle), further moulding the wet precursor in a mould to produce a further-moulded receptacle, coating the further-moulded receptacle to produce a coated moulded receptacle, drying the coated moulded receptacle to produce a dried receptacle, and applying a closure to the dried receptacle. As will be apparent at least from the following description, modifications may be made to the exemplary process to provide variants thereof in which other examples of the present invention may be embodied.

In this example, providing the fibre suspension comprises preparing the fibre suspension from ingredients thereof. More specifically, the preparing comprises providing pulp fibres, such as paper pulp fibres, and mixing the pulp fibres with a liquid to provide hydrated pulp fibres. In this example, the pulp fibres are provided in sheet form from a supplier and the liquid comprises water and one or more additives. In this example, the liquid is mixed with the pulp fibres to provide hydrated pulp fibres having a solid fibres content of 1 wt % to 5 wt % (by dry mass of fibres). In examples, the one or more additives includes a shorting agent, such as alkylketene dimer (AKD). The hydrated pulp fibres typically comprise AKD in an amount of 0.4 wt % with respect to the total dry mass of the solid fibres in the hydrated pulp fibres. In some examples, one or more additives are present in the liquid at the point of mixing the pulp fibres with the liquid In some examples, one or more additives are included in the hydrated pulp fibres after mixing the pulp fibres with the liquid (e.g. the pulp fibres are hydrated for a period of time, such as from 2 to 16 hours, and then one or more additives are supplied to the hydrated pulp fibres). The hydrated pulp fibres are passed between plates of a valley beater 11 or refiner that are in motion relative to each other. This fibrillates some, or all, of the fibres, meaning that cell walls of those fibres are caused to become partially delaminated so that wetted surfaces of those fibres comprise protruding hairs or fibrillations. These fibrillations will help to increase a strength of bonds between the fibres in the dried end product. In other examples, the valley beater 11 or refiner may be omitted.

The resultant processed pulp is stored in a vat 12 in a relatively concentrated form (e.g., a solid fibres content of 1 wt % to 5 wt %) to reduce a required storage space. At an appropriate time, the processed pulp is transferred to a mixing station 13 at which the processed pulp is diluted in further water and, optionally, mixed with one or more additives (as well as, or in place of, the one or more additives provided with the hydrated pulp fibres) to provide the fibre suspension ready for moulding. In this example, the solid fibres account for 0.7 wt % of the resultant fibre suspension (by dry weight of fibres), but in other examples the proportion of solid fibres in the fibre suspension may be different, such as another value in the range of 0.5 wt % to 5 wt %, or 0.1 wt % to 1 wt %, of the fibre suspension (by dry weight of fibres). In some examples, the one or more additives mixed with the processed pulp and water includes a dewatering agent, such as modified and/or unmodified polyethylene imine (PEI), e.g., modified PEI sold under the trade name Polymin® SK. In some examples, the one or more additives are mixed with the water, and the water and one or more additives subsequently mixed with the processed pulp; in other examples, the processed pulp and water are mixed, and the one or more additives subsequently mixed with the processed pulp and water. The fibre suspension typically comprises Polymin® SK in an amount of 0.3 wt % with respect to the total dry mass of the solid fibres. Mixing of the fibre suspension at the mixing station 13 helps to homogenise the fibre suspension. In other examples, the processed pulp or the fibre suspension may be provided in other ways, such as being supplied ready-made.

In this example, the porous first mould 15 comprises two half-moulds that are movable towards and away from each other, in this case using a hydraulic ram. In this example, each of the half-moulds is a monolithic or unitary tool formed by additive manufacturing (e.g., 3D-printing) that defines a mould profile, and, when the half-moulds are brought into contact with each other, their respective mould profiles cooperate to define the mould cavity in which the wet precursor or moulded receptacle is to be formed. Each half-mould may itself define a smaller moulding cavity and, when brought into cooperation with a second half-mould, the smaller moulding cavities may combine to provide the overall mould cavity. The two half-moulds may themselves be considered “splits” or “moulds” and the overall porous first mould 15 may be considered a “split-mould” or, again, a “mould”. In other examples, the porous first mould 15 may comprise more than two splits, such as three, four or six splits, that cooperate to define the moulding cavity.

In FIG. 1, the fibre suspension (also known as slurry) is top-filled into the porous mould 15, in contrast to moulding processes that dip a mould in slurry. The fibre suspension is drawn under vacuum via a line 16 and into the porous mould 15, with excess suspending liquid being drawn through the porous mould 15 under vacuum via a line 18 into a tank 17. Shot mass may be controlled by measuring (e.g., weighing) the amount of liquid drawn into the tank 17. A weight scale platform supporting the tank 17 is visible in FIG. 1. Once a required amount (e.g., a predetermined volume, such as 10 litres, or a predetermined mass, such as 10 kilograms) of liquid has been collected in the tank 17, suction of the suspending liquid through the porous mould 15 is stopped and the porous mould 15 is opened to ambient air. In this example, the suspending liquid drawn with the fibre suspension in line 16 is water, or predominantly water (as additives may also be present). The liquid drawn under vacuum via the line 18 and into the tank 17 is substantially free of fibres, since these are left behind against the walls of the porous mould 15 to form an embryo of the moulded receptacle.

In one form, in order to remove further suspending liquid (e.g., water) from the embryo, and form or consolidate the three-dimensional shape of the receptacle, an impermeable inflation element 19, e.g., a collapsible bladder, is inserted into the porous mould 15 and expanded to act as an internal high-pressure core structure for the porous mould 15. This process strengthens the wet embryo so that it can be handled, and displaces water from in between the fibres, thereby increasing the efficiency of a subsequent drying process. The inflation element 19 is actuated and regulated using a hydraulic pump 20. The pump 20 has a cylinder that displaces a fluid in a line 21 into the inflation element 19, to expand the inflation element 19 radially and into conformity with the mould cavity. Fluid within the line 21 is preferably non-compressible, such as water. Water also has the advantage over other non-compressible liquids that any leaking or bursting of the bladder 19 will not introduce a new substance to the system (since the suspending liquid is already water, or predominantly water).

Demoulding occurs when the porous mould 15 opens for removal of the self-supporting moulded receptacle 22. Mould cleaning 23 is preferably performed subsequently, to remove small fibres and maintain a porosity of the porous mould 15. In this example, a radially firing high-pressure jet is inserted into the mould cavity while the mould 15 is open. This dislodges fibres from the wall of the mould cavity. Alternatively, or in addition, water from the tank 17 is pressurised through the back of the porous mould 15 to dislodge entrapped fibres. Water is drained for recycling back to an upstream part of the system. It is noteworthy that cleaning is important for conditioning the porous mould 15 for re-use. The porous mould 15 may appear visibly clean after removal of the receptacle, but its performance could be compromised without cleaning.

According to FIG. 1, the formed but unfinished receptacle 22 is subsequently transported to a second moulding station where, in a, e.g., aluminium, mould 25, pressure and heat are applied for thermoforming a desired neck and surface finish, optionally including embossed and/or debossed surface features. After two halves of the mould 25 have closed around the receptacle 22, a pressuriser is engaged. For example, a bladder 26 (e.g., a thermoforming bladder 26) is inserted into the receptacle 22. The bladder 26 is inflated via a line 27 by a pump 28 to supply pressurised fluid, e.g., air, water, or oil. Optionally, during supply, the pressurised fluid is heated with e.g., a heater or, alternatively, is cooled with e.g., a heat exchanger. An external mould block 24 of the mould 25, and/or the mould 25 itself, may also, or alternatively, be heated. A state of the moulded receptacle 22 after thermoforming is considerably more rigid, with more compressed side walls, compared with the state at demoulding from the porous mould 15.

A drying stage 29 (e.g., a microwave drying process or other drying process) is performed downstream of the thermoforming, as shown. In one example, the drying stage 29 is performed before thermoforming. However, moulding in the mould 25 requires some water content to assist with bonding during the compression process. FIG. 1 illustrates a further drying stage 30 after the drying stage 29, which may utilise hot air circulated onto the moulded receptacle 22, e.g., in a “hot box”. In some examples, microwave or other drying processes may be performed at plural stages of the overall manufacturing process.

The moulded receptacle 22 is then subjected to a coating stage during which, in this example, a spray lance 31 is inserted into the moulded receptacle 22 and applies one or more surface coatings to internal walls of the moulded receptacle 22. In another example, the moulded receptacle 22 is instead filled with a liquid that coats the internal walls of the moulded receptacle 22. In practice, such coatings provide a protective layer to prevent egress of contents into the bottle wall, which may permeate and/or weaken it. Coatings will be selected dependent on the intended contents of receptacle 22, e.g., a beverage, detergent, pharmaceutical product, etc. In some examples, the further drying stage 30 is performed after the coating stage (or both before and after the coating stage). In this example, the moulded receptacle 22 is then subjected to a curing or drying process 34, which can be configured or optimised dependent on the coating, e.g., drying for twenty-four hours at ambient conditions or by a flash drying method. In some examples, e.g., where the further drying stage 30 occurs after the coating stage, the curing process 34 may be omitted.

At an appropriate stage of production (e.g., during thermoforming, or before or after coating) a closure or mouth forming process may be performed on the moulded receptacle 22. For example, as shown in FIG. 1, a neck fitment 35 may be affixed. In some examples, an exterior coating is applied to the moulded receptacle 22, as shown in the further coating stage 32. In one example, the moulded receptacle 22 is dipped into a liquid that coats its outer surface, as shown in FIG. 1. One or more further drying or curing processes may then be performed. For example, the moulded receptacle 22 may be allowed to dry in warm air. The moulded receptacle 22 may therefore be fully formed and ready to accept contents therein.

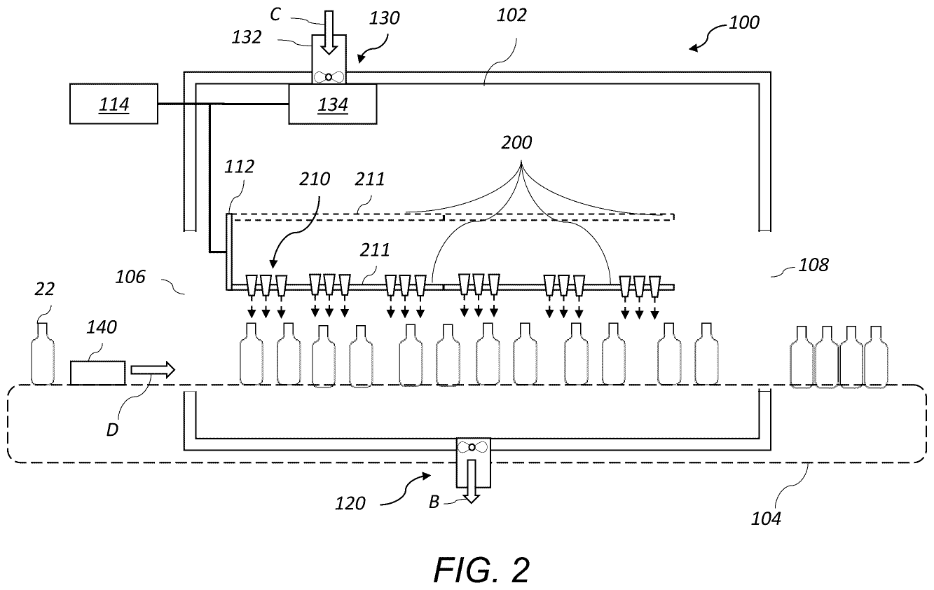

FIG. 2 is a schematic diagram of a fibre-based receptacle drying system 100 for use in drying an interior of a receptacle formed from a fibre suspension, for example a receptacle 22 as described with reference to FIG. 1. The system 100 may be used at any appropriate point in the exemplary process of FIG. 1, for example, such as during (or instead of) one or more of the drying stages 29, 30 and 34.

The system 100 comprises a drying chamber 102 through which a plurality of receptacles 22, having respective openings, pass during drying thereof by the system 100. The receptacles 22 are supported on a receptacle support 104, which in this example is an air-permeable belt 104. The belt 104 passes from an inlet 106 of the drying chamber 102 to an outlet 108 of the drying chamber 102, in a direction of movement denoted by arrow D in FIG. 2, at a variable speed of from 5 m/hr to 15 m/hr. In other examples, the speed is from 0.1 m/hr to 100 m/hr. In this example, a return section of the belt 104 passes beneath the drying chamber 102, but in other examples the return section of the belt 104 passes through the drying chamber 102. In this example a single belt 104 is employed, but in other examples two or more belts may be positioned in series or in parallel. In some cases, the belts operate at different speeds to one another.

The inlet 106 and the outlet 108 of the heating chamber 102 are of sufficient height and width to permit respective entry and exit of the receptacles 22 and other articles, such as those of greater size than the mouldings depicted in FIG. 2.

The system 100 comprises two nozzle modules 200 positioned above the belt 104. Each nozzle module 200 comprises a tray 211 and plural groups of nozzles 210 supported by the tray 211. The plural groups of nozzles 210 are aligned successively along a linear path that extends parallel to the direction of movement D. Although shown with three groups of nozzles 210 on each nozzle module 200, in other examples the number of groups of nozzles 210 is different. Some example nozzle modules 200 have around fifteen groups of nozzles 210, extending along a path of around 1.5 m in length. Although shown with three nozzles in each group of nozzles 210, in other examples, each group of nozzles 210 may comprise a different number of nozzles. Movement of the belt 104 in the direction of movement D causes relative movement of the receptacle 22 and the nozzles 210.

Each of the nozzles in the groups of nozzles 210 is configured to direct a respective airflow substantially vertically downwards towards the air-permeable belt 104, and thus into an opening of a receptacle 22 when the receptacle 22 is positioned below the nozzle. The respective airflows are emitted at a speed of around 3 m/s, which provides a balance between drying time and reducing the risk of damaging the receptacle or coatings thereon. In other examples, the airflow speed may be different.

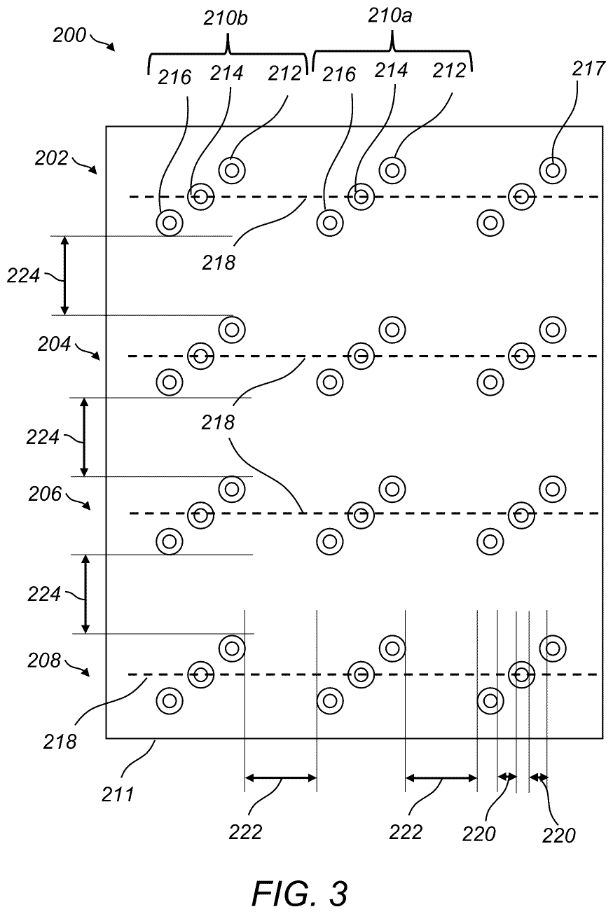

The nozzles in a group of nozzles 210 are offset laterally and longitudinally from one another with respect to the direction of movement D, as discussed in more detail hereinafter with reference to FIGS. 3-5B. Accordingly, in use, during the relative movement, the respective airflows are successively and non-concurrently directed into different respective regions of the opening of the receptacle 22. The respective airflows therefore do not interfere with one another as they travel through the interior of the receptacle 22.

A spacing between adjacent groups of the groups of nozzles 210 along the path is greater than each spacing between adjacent nozzles within any one of the groups of nozzles 210, as discussed in more detail hereinafter with reference to FIGS. 3-5B. This helps to ensure that the airflows from one group of nozzles 210 have fully exited the receptacle 22 before the receptacle 22 is aligned with a subsequent group of nozzles 210.

The tray 211 of each nozzle module 200 is movably fixed to an adjuster 112, which in this example is a track 112, such that movement of the tray 211 along the track 112 changes a distance between the groups of nozzles 210 and the receptacle support 104, and thus the tops of the receptacles 22 in use, as demonstrated by the alternative position of the nozzle modules 200 shown in dashed lines in FIG. 2. The position of the tray 211 on the track 112 is determined by a control system 114 and is based on a height of the receptacle 22. In this example, a vertical gap between the groups of nozzles 210 and the top of the receptacle 22 is around 2.5 cm. It will be appreciated that in other examples, any suitable mechanism for adjusting the distance between the groups of nozzles 210 and the receptacle support 104, and thus the tops of the receptacles 22 in use, may be employed, including manual adjustment. In other examples, the belt 104 is vertically movable within the drying chamber 102 towards and away from the tray 211.

The system 100 comprises an exhaust system 120 to draw out air from the drying chamber 102, as denoted by arrow B. The exhaust system 120 is positioned below the nozzle modules 200, such that airflows emitted from the groups of nozzles 210 are generally directed towards the exhaust system 120. The airflows may become more saturated than ambient air during drying by the system 100 so it may be beneficial for the airflows to be drawn out of the drying chamber 102 relatively quickly.

The system 100 comprises a recirculation system 130 to direct air, via a transfer duct (not shown) from the exhaust system 120 to an inlet duct 132, as denoted by arrow C. The inlet duct 132 is connected to each of the nozzles in the plural groups of nozzles 210 to deliver air to each nozzle.

The system 100 comprises a heater 134, which in this example forms part of the recirculation system 130. The heater 134 heats airflow entering the drying chamber 102 via the inlet duct 132 such that the airflows emitted by the groups of nozzles 210 have a higher temperature than an ambient temperature. In this example, the heater 132 is configured to heat the airflow to a temperature of around 65 degrees Centigrade. In other examples, the system 100 may comprise a plurality of heaters 134 configured to heat the airflows emitted from one of the groups of nozzles 210 to a different temperature to the airflows emitted from another of the groups of nozzles 210.

Although not shown, the system 100 comprises a plurality of sensors to sense a temperature and a humidity of air within the drying chamber 102. The control system 114 is operable to control the exhaust system 120 and the recirculation system 130 during drying by the system 100 based on the sensed temperature and humidity. In an example, the control system 114 is configured to determine whether the humidity of air in the drying chamber 102 exceeds an activation humidity threshold. In the event that the activation humidity threshold is exceeded, the control system 114 is configured to activate the exhaust system 120 and recirculation system 130 until the control system 114 determines that the humidity of air in the drying chamber 102 is below a deactivation humidity threshold.

The system 100 comprises an alignment mechanism 140, which in this example is in the form of two opposing walls upstream of the inlet 106 of the drying chamber 102. The opposing walls are further apart at a distal end of the alignment mechanism 140, relative to the inlet 106 than at a proximal end of the alignment mechanism 140, relative to the inlet 106 and are centred about the path along which the plural groups of nozzles 210 are arranged. A distance between the proximal end of the alignment mechanism 140 is substantially equal to a diameter of the receptacle 22. As the receptacle 22 is carried towards the inlet 106 on the air-permeable belt 104, the walls of the alignment mechanism 140 push on an outer wall of the receptacle 22 until the receptacle passes between the proximal ends and is therefore aligned with the path. In other examples, the alignment mechanism 140 may take any other suitable form.

Although one row of plural groups of nozzles 210 is shown in FIG. 2, each nozzle module 200 comprises plural rows of plural groups of nozzles 210, as described in more detail with reference to FIG. 3. This may increase the receptacle drying capacity of the system 100.

FIG. 3 is a plan view of one of the nozzle modules 200 shown in FIG. 2. The nozzle module 200 comprises a plurality of rows 202, 204, 206, 208 of groups of nozzles 210 disposed on a tray 211 having plural groups of holes to accommodate respective groups of nozzles 21. Although shown with three nozzles 212, 214, 216, in other examples each group of nozzles 210 comprises a different number of nozzles. Although shown with four rows 202, 204, 206, 208, in other examples the nozzle module 200 comprises a different number of rows. Although shows as linear rows, in other examples the rows may be non-linear, for example curved. Although shown with three groups of nozzles 210 in each row 202, 204, 206, 208, each row 202, 204, 206, 208 may alternatively comprise a different number of groups of nozzles 210. In another example, each row comprises around 15 groups of nozzles 210 and has a length of around 1.5 m.

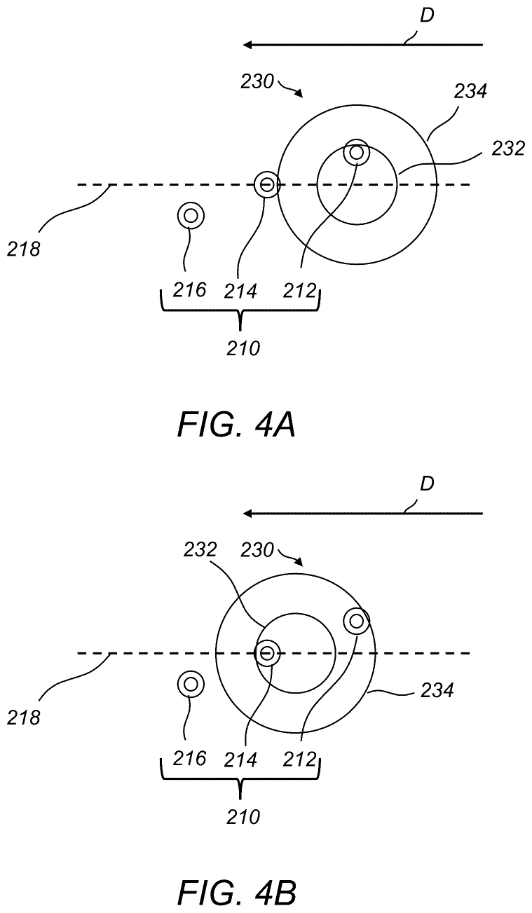

Each nozzle 212, 214, 216 in a group of nozzles 210 is configured to emit a respective airflow. The nozzles 212, 214, 216 in each group of nozzles 210 are arranged relative to one another along a diagonal line that extends laterally and longitudinally relative to a respective path 218 defined by the respective row 202, 204, 206, 208. Accordingly, the respective airflows are directed into an opening of the receptacle at different positions offset from a centre of the opening as the receptacle is moved along the respective row 202, 204, 206, 208, as described in more detail hereinafter with reference to FIGS. 4A-4D.

The groups of nozzles 210 in a respective row 202, 204, 206, 208 are aligned successively along the respective path 218 defined by the respective row 202, 204, 206, 208. In use, for example in use in the fibre-based receptacle drying system 100 described with reference to FIG. 2, the receptacle 22 is moved relative to the nozzle module 200 parallel to the respective path 218 such that airflows emitted from a first group of nozzles 210a are directed into the opening of the receptacle before airflows emitted from a second group of nozzle 210b downstream of the first group of nozzles are directed into the opening.

In this example, each nozzle 212, 214, 216 in one of the groups of nozzles 210 is aligned with a respective nozzle 212, 214, 216 in each of the other groups of nozzles 210 in a direction parallel to the path 218. In this example, a first nozzle 212 in each of the groups of nozzles 110 is positioned to a first side of the path 218 at a first distance from the path 218. A second nozzle 214 in each of the groups of nozzles 110 is positioned on the path 218. A third nozzle 216 in each of the groups of nozzles 110 is positioned to a second side of the path 218, opposite to the first side, at a second distance from the path 218. In this example the first and second distances are substantially equal. This provides a repeatable pattern of airflows entering the opening of the receptacle 22 as the receptacle travels along the path 218.

In this example, each of the nozzles 212, 214, 216 has an interior aperture 217 with a diameter of around 7 mm and is arranged to direct air into an opening having a diameter of around 35 mm. Alternative interior aperture 217 diameters are possible, but should be smaller than the diameter of the opening of the receptacle 22 to facilitate evacuation of air from the receptacle 22. It may be generally beneficial for the diameter of the interior aperture 217 to be substantially smaller, around 4-8 times smaller, than the diameter of the opening of the receptacle 22. Accordingly, the airflows travel along sides of the receptacle with enhanced directionality compared with an airflow emitted from a nozzle having an interior aperture 217 with a diameter closer to the diameter of the opening.

The interior apertures 217 of adjacent nozzles 212, 214, 216 in a group of nozzles 210 are separated by a longitudinal distance 220, parallel to the path 218, that is to ensure that the respective airflows enter the opening of the receptacle non-sufficient concurrently. Accordingly, the airflows do not interfere with one another within the interior of the receptacle 22.

A longitudinal gap 222, parallel to the path 218, between the third nozzle 216 in a group of nozzles 210 and the first nozzle 212 in an adjacent group of nozzles 210 in a row 202, 204, 206, 208 is greater than the longitudinal distance 220 between adjacent nozzles 212, 214, 216 in a single group of nozzles 210. This can help to ensure that the airflows emitted by one group of nozzles 210 have fully exited the receptacle 22 before an airflow from an adjacent group of nozzles 210 enters the receptacle 22.

The rows 202, 204, 206, 208 are arranged at substantially equal distances 224 from one another. The distance 224 between nozzles 212, 214, 216 in a first row 202 of the rows 202, 204, 206, 208 and the nozzles 212, 214, 216 in an adjacent second row 204 of the rows 202, 204, 206, 208 is greater than the longitudinal gap 222 between adjacent groups of nozzles 210 in each of the first and second rows 202, 204. This can help to prevent receptacles 22 travelling along adjacent paths 218 from contacting one another, which may reduce a risk of damaging an outer surface of the receptacles 22.

FIGS. 4A-4D schematically show plan views of a receptacle, in this case a bottle 230, at different respective positions relative to a group of nozzles 210 of the nozzle module 200 shown in FIG. 3. The bottle 230 has a central opening 232 having a smaller diameter than an outer wall 234 of a main body of the bottle 230. In this example, the bottle 230 is moved relative to the group of nozzles 210 on the receptacle support 104 described above with reference to FIG. 2.

In FIG. 4A, a first nozzle 212 of the group of nozzles 210 is aligned with the opening 232 of the bottle 230. In use, the airflow emitted by the first nozzle 212 is directed down a right side (as viewed in FIG. 4A relative to the direction of relative movement indicated by arrow D) of the interior of the bottle 230, then travels along a base of the bottle 230 and up a left side of the bottle 230 before exiting the bottle 230 via the opening 232. During movement of the bottle 230 parallel to the path 218, the opening 232 moves relative to the first nozzle 212 and thus the airflow emitted from the first nozzle 212 travels along varying routes through the interior of the bottle 230, though all generally starting on the right side of the bottle 230. Therefore, a relatively large surface area of the interior of the bottle 230 is travelled over by the airflow compared to the diameter of the internal aperture 217 of the nozzle 212.

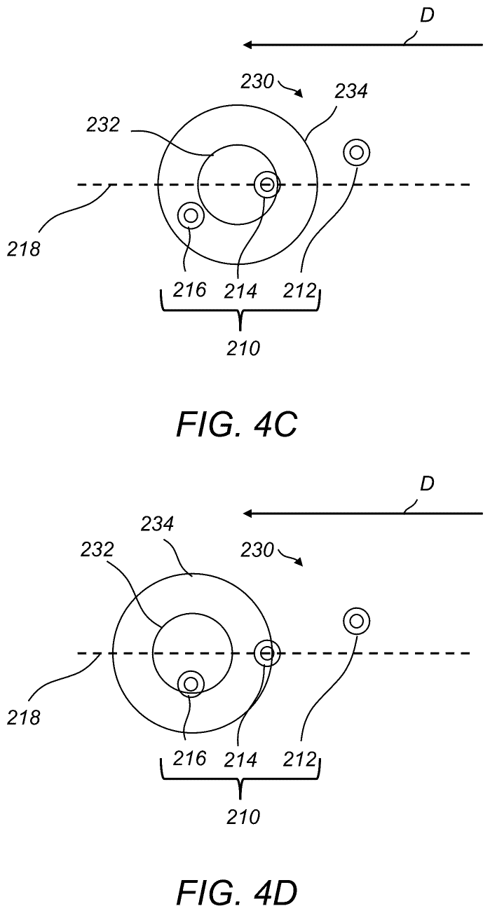

In FIG. 4B, a second nozzle 214 of the group of nozzles 210 is aligned with the opening 232 of the bottle 230. In use, the airflow emitted by the second nozzle 214 is directed down a leading side (as viewed in FIG. 4B relative to the direction of relative movement indicated by arrow D) of the interior of the bottle 230, then travels along the base of the bottle 230 and up a trailing side of the bottle 230 before exiting the bottle 230 via the opening 232. In FIG. 4C, the second nozzle 214 is still aligned with the opening 232 of the bottle 230. In this position, the airflow emitted by the second nozzle 214 is directed down the trailing side (as viewed in FIG. 4C relative to the direction of relative movement indicated by arrow D) of the interior of the bottle 230, then travels along the base of the bottle 230 and up the leading side of the bottle 230 before exiting the bottle 230 via the opening 232. During movement of the bottle 230 parallel to the path 218 between the positions shown in FIGS. 4B and 4C, the airflow emitted by the second nozzle 214 crosses the opening 232 and thus in some positions the airflow is not specifically directed along a side of the bottle 230, as best shown in FIG. 5A.

In FIG. 4D, a third nozzle 216 of the group of nozzles 210 is aligned with the opening 232 of the bottle 230. In use, the airflow emitted by the third nozzle 216 is directed down the left side (as viewed in FIG. 4A relative to the direction of relative movement indicated by arrow D) of the interior of the bottle 230, then travels along the base of the bottle 230 and up the right side of the bottle 230 before exiting the bottle 230 via the opening 232. During movement of the bottle 230 parallel to the path 218, the opening 232 moves relative to the third nozzle 216 and thus the airflow emitted from the third nozzle 216 travels along varying routes through the interior of the bottle 230, though all generally starting on the left side of the bottle 230. Therefore, a relatively large surface area of the interior of the bottle 230 is travelled over by the airflow compared to the diameter of the internal aperture 217 of the nozzle 216.

FIGS. 5A and 5B show side cross-sectional views of the bottle 230 as its interior is dried by the second nozzle 214 in the group of nozzles 210 of the nozzle module 200. In FIG. 5A, the bottle 230 is at a position between the positions shown in FIGS. 4B and 4C. That is, the nozzle 214 is aligned with a centre of the opening 232. The arrows show an approximation of the route that the airflow emitted from the nozzle 214 travels through the interior of the bottle 230. The airflow is directed straight towards the base 240 of the bottle 230. A shoulder 236 of the bottle 230 between the opening 232 and the outer wall 234 of the main body causes “dark spots” 238 that the airflow does not reach, or only reaches when the airflow is exiting the bottle 230 and is therefore relatively saturated compared with the airflow entering the bottle 230. Accordingly, were the airflow only directed into the bottle 230 at a centre of the opening 232, these “dark spots” would dry more slowly than other areas of the interior of the bottle 230.

In FIG. 5B, the bottle 230 is at the same position relative to the group of nozzles 210 as that shown in FIG. 4B. The arrows show an approximation of the route that the airflow emitted from the nozzle 214 travels through the interior of the bottle 230. In contrast to the airflow route shown in FIG. 5A, by directing the airflow along the side of the opening 232, the airflow ‘sticks’ to the interior sides of the bottle 230 as the airflow travels over the shoulder 236 and therefore travels through the “dark spots” 238, resulting in more uniform drying of the interior of the bottle 230. In the position shown in FIG. 5B, relatively dry air entering the bottle 230 passes through the leftmost “dark spot” 238 of FIG. 5B and relatively saturated air exiting the bottle 230 passes through the rightmost “dark spot” of FIG. 5B.

When the bottle 230 is at the same position relative to the group of nozzles 210 as that shown in FIG. 4C, the route that the airflow emitted from the nozzle 214 travels through the interior of the bottle 230 will be reversed compared with the route shown in FIG. 5B. In such a position as shown in FIG. 4C, relatively dry air entering the bottle 230 passes through the rightmost “dark spot” 238 of FIG. 5B and relatively saturated air exiting the bottle 230 passes through the leftmost “dark spot” of FIG. 5B. Accordingly, over time, relatively dry air entering the bottle 230 passes through both of the “dark spots” 238 during movement of the bottle 230 relative to a group of nozzles 210 in the direction of movement D.

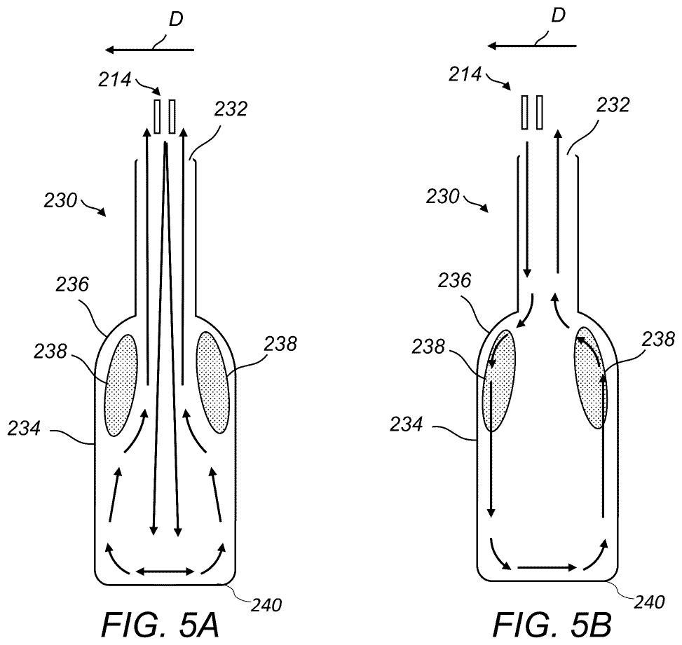

FIG. 6 shows an example method 300 of drying an interior of a receptacle formed from a fibre suspension, for example a receptacle 22 described above with reference to FIG. 1. The method 300 may form part of the process described above with reference to FIG. 1, for example be performed as part of the drying stages 29, 30 or the curing process 34.

The method 300 comprises, as shown in block 302, successively and non-concurrently emitting plural airflows from respective nozzles of a group of nozzles into an opening of a receptacle at different respective positions relative to, and offset from, a centre of the opening. Accordingly, the airflows travel along different routes within the interior of the receptacle so that a greater surface area of the interior of the receptacle is contacted by the airflows compared to when a single airflow is directed into the opening. By directing the airflows successively and non-concurrently, the airflows do not interfere with one another as they flow along the sides of the interior of the receptacle, which may help to reliably remove moisture from the receptacle. In other examples, the plural airflows may be directed into the opening concurrently, which may increase airflow within the interior of the receptacle, but interference may impede egress of the airflows from the interior of the receptacle.

Emitting the airflow from a nozzle may provide better directionality of airflow compared to emitting airflow from a hole, for example, which can enable more of the airflow to be caused to travel along the side of the interior of the receptacle.

In some examples, the method 400 comprises directing two or more than three airflows into the opening of the receptacle. However, examples in which three airflows are provided has been found to provide sufficient coverage of the interior of the receptacle by the three airflows to dry the interior substantially uniformly.

The airflows have a speed of around 3 m/s and a temperature of around 65 degrees Centigrade. In general, a hotter, faster airflow enables faster drying, but this increases a risk of potential heat-related damage to the receptacle or coatings thereon. Cooler, slower airflows result in slower or non-uniform drying. The chosen airflow parameters should provide a balance between drying time and reducing the risk of overheating the receptacle or coatings thereon. By emitting airflows having substantially the same parameters in each drying cycle, more controllability over the drying may be provided.

The method 300 further comprises, as shown in block 304, causing relative movement of the receptacle and the group of nozzles. Such relative movement may be caused, for example, by positioning the receptacle on a support that is movable relative to the nozzle. Causing relative movement of the receptacle and the nozzle causes the position at which the airflow is directed into the opening to change over time. In turn, this causes the airflow to travel along a greater surface area of the interior of the receptacle compared to the receptacle and nozzle being stationary relative to one another.

The nozzles in the group of nozzles are offset from one another in a direction parallel to and in a direction normal to the relative movement by such a distance that each respective airflow enters the opening of the receptacle successively and non-concurrently.

In this example, the group of nozzles comprises three nozzles and the method 300 comprises emitting first, second and third airflows from respective first, second and third nozzles. The first nozzle is positioned upstream and to the left of the second and third nozzles relative to the direction of movement. The second nozzle is positioned downstream and to the right of the first nozzle relative to the direction of movement and is aligned with the centre of the opening along the direction of movement. The third nozzle is positioned downstream and to the right of the second nozzle relative to the direction of movement. Accordingly, during the relative movement of the receptacle and the three nozzles, the first airflow is first directed into the opening and along a left side, relative to the direction of movement, of the interior of the receptacle. The second airflow is then directed into the opening and along a leading side, relative to the direction of motion, of the interior of the receptacle. The second airflow is then directed towards the centre of the opening and then along a trailing side, relative to the direction of motion, of the interior of the receptacle. Finally, the third airflow is directed into the opening and along a right side, relative to the direction of motion, of the interior of the receptacle.

The method 300 further comprises, as shown in block 306, emitting respective airflows from a plurality of further groups of nozzles downstream from the group of nozzles, with respect to the relative movement. The nozzles in each of the plurality of further groups of nozzles are each arranged identically to the nozzles of the group of nozzles described. By repeatedly directing airflows into the opening of the receptacle during the relative movement, lower temperature and airflow speeds can be used to effect drying of the interior of the receptacle. Further, multiple receptacles may be dried concurrently.

The method 300 further comprises, as shown in block 308, emitting additional airflows towards an outer surface of the receptacle to concurrently dry an exterior of the receptacle.

In some examples, one or more of the parts of the method 300 described with reference to blocks 304,306 and 308 may be omitted. In some examples, the directing may not be substantially vertically downwards. For example, in some examples, the receptacle is laid on its side and the directing may be substantially horizontal. In some examples, the relative movement may be omitted. In such examples, the nozzles in the group of nozzles are sized and arranged relative to the opening such that the airflow from each respective nozzle in the group of nozzle takes a different route through the interior of the receptacle to each of the other airflows. Multiple successive airflows are emitted from each nozzle into the opening to dry the interior of the receptacle.

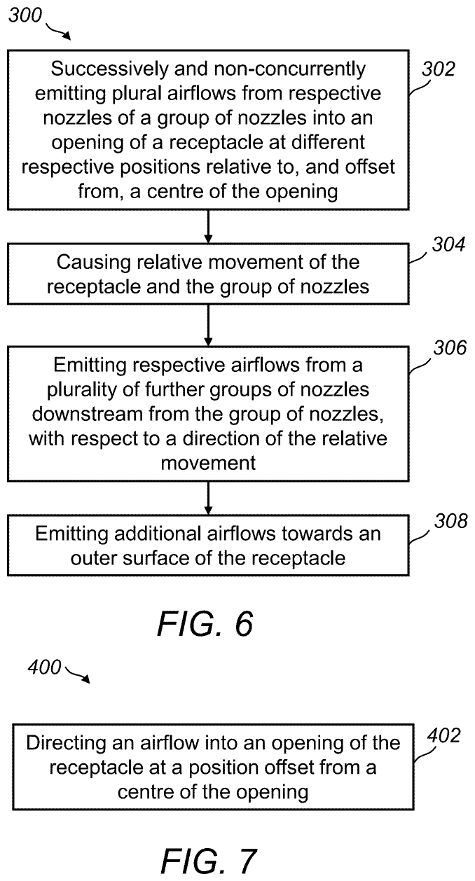

FIG. 7 shows another method 400 according to an example. The method 400 may form part of the process described above with reference to FIG. 1, for example be performed as part of the drying stages 29, 30 or the curing process 34.

The method 400 comprises, as shown in block 402, directing an airflow into an opening of the receptacle at a position offset from a centre of the opening such that the airflow travels along a side of the interior of the receptacle. The directing enables drying of an interior of the receptacle and drying of any interior coating, or coatings, of the receptacle. By directing the airflow at the offset position, the airflow is caused to flow along the side of the interior of the receptacle towards a base of the receptacle, along the base of the receptacle, and then along another side of the interior of the receptacle towards and through the opening. This helps to remove moisture from the interior of the receptacle compared to directing airflow at a centre of the opening. The method 400 may further comprise any of the parts of the method 300 described with reference to FIG. 6.

The methods 300, 400, or other methods that fall within the scope of the claims, may, for example, be performed by the fibre-based receptacle drying system 100 described with reference to FIG. 2 or variants thereof discussed herein.

Example embodiments of the present invention have been discussed, with reference to the examples illustrated. However, it will be appreciated that variations and modifications may be made without departing from the scope of the invention as defined by the appended claims.

What is claimed is:

1. A method of drying an interior of a receptacle formed from a fibre suspension, the method comprising directing an airflow into an opening of the receptacle at a position offset from a centre of the opening.

2. The method of claim 1, wherein the directing comprises directing the airflow into the opening of the receptacle at the position offset from the centre of the opening such that the airflow travels along a side of the interior of the receptacle.

3. The method of claim 1, comprising emitting the airflow from a nozzle, and causing relative movement of the receptacle and the nozzle.

4. The method of claim 3, wherein the relative movement is in a first direction and the position is a position offset laterally, relative to the first direction, from the centre of the opening.

5. The method of claim 1, wherein the airflow has a speed from 0.5 m/s to 5 m/s.

6. The method of claim 1, wherein the airflow has a temperature from 40 to 100 degrees Centigrade.

7. The method of claim 1, comprising directing plural airflows into the opening of the receptacle, wherein at least two of the plural airflows are directed into the opening at different respective positions relative to, and offset from, the centre of the opening, wherein the magnitudes of the respective offsets are such that the at least two airflows travel from the opening along different sides of the interior of the receptacle.

8. The method of claim 7, comprising directing the plural airflows into the opening of the receptacle non-concurrently to one another.

9. The method of claim 7, comprising:
emitting each of the plural airflows from a respective one of a plurality of nozzles; and
causing relative movement of the receptacle and the plurality of nozzles, wherein the nozzles are offset from one another in a direction of the relative movement.

10. The method of claim 9, wherein at least two of the plurality of nozzles are offset from one another in a direction normal to the relative movement.

11. A nozzle module for use in drying an interior of a receptacle formed from a fibre suspension, the nozzle module comprising plural groups of nozzles,
wherein the groups of nozzles are aligned successively along a path, and
wherein the nozzles in each group of nozzles are laterally offset from one another, relative to the path, such that, in use, the nozzles in a group of nozzles are configured to emit respective airflows into different respective regions of an opening of the receptacle.

12. The nozzle module of claim 11, wherein the nozzles in each of the groups of nozzles are longitudinally offset from one another along the path.

13. The nozzle module of claim 11, wherein each nozzle in one of the groups of nozzles is aligned with a respective nozzle in each of the other groups of nozzles in a direction parallel to the path.

14. The nozzle module of claim 11, comprising plural parallel rows of nozzles, each row comprising a respective plurality of groups of nozzles, wherein the nozzles in a first row of the rows are spaced apart from the nozzles in an adjacent second row of the rows by a distance that is greater than a distance between adjacent groups of nozzles in each of the first and second rows.

15. A fibre-based receptacle drying system for use in drying an interior of a receptacle formed from a fibre suspension, the drying system comprising:
a receptacle support to support the receptacle; and
a group of nozzles arranged to direct respective airflows towards the receptacle support, wherein the receptacle support and the group of nozzles are relatively movable in a direction of movement, and
wherein the nozzles in the group of nozzles are offset laterally and longitudinally from one another with respect to the direction of movement, such that, in use, during the relative movement, the respective airflows are successively directed into different respective regions of an opening of the receptacle.

16. The fibre-based receptacle drying system of claim 15, comprising a drying chamber between the group of nozzles and the receptacle support, and an exhaust system to draw out air from the drying chamber.

17. The fibre-based receptacle drying system of claim 15, comprising an adjuster to adjust a distance between the nozzles and the receptacle support.

18. The fibre-based receptacle drying system of claim 15, comprising a heater configured to cause the respective airflows to have a temperature greater than an ambient temperature.

19. The fibre-based receptacle drying system of claim 15, comprising plural groups of nozzles aligned successively along a path, wherein a spacing between adjacent groups of the groups of nozzles along the path is greater than each spacing between adjacent nozzles within any one of the groups of nozzles.

20. A receptacle produced by the process comprising: directing an airflow into an opening of the receptacle at a position offset from a centre of the opening.
